(19) United States
(12) Patent Application Publication
(10) Pub. No.: US 2014/0347849 A1
(43) Pub. Date: Nov. 27, 2014

(54) LIGHT-EMITTING DIODE LAMP

(71) Applicants: Foxconn Technology Co., Ltd., New Taipei (TW); CHAMP TECH OPTICAL (FOSHAN) CORPORATION, Foshan (CN)

(72) Inventors: WEN XU, Foshan (CN); MIN-CHI ZENG, Foshan (CN)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 14/210,481

(22) Filed: Mar. 14, 2014

(30) Foreign Application Priority Data
May 24, 2013 (CN) 2013101976666

(51) Int. Cl. F21K 99/00

(52) U.S. Cl. CPC F21K 9/175
USPC 362/217.17

(57) ABSTRACT

A light-emitting diode lamp comprises a frame defining a pair of slots therein, a light bar fixed on the frame at one side thereof by pushing the light bar into the slots, a driving module mounted on the frame at the other side thereof, and a lamp cover fixed on the frame and covering the light bar. The light bar is inserted into the slots of the frame to be mounted in the light-emitting diode lamp. The driving module electrically connects with the light bar. The slots are defined in two walls of the frame wherein the two walls extend away from each other along a radiating direction of the light bar.

### BACKGROUND

1. Technical Field

The present disclosure generally relates to illuminating apparatus, and particularly to a light-emitting diode (LED) lamp having an LED light bar inserted in a frame of the LED lamp.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

An LED lamp generally includes a casing, a light bar and a lamp cover. The light bar includes a supporting salver and a plurality of LEDs mounted on the supporting salver. Different light bars may have LEDs with different numbers or in different arrangements to generate different light distributions, thereby meeting different light distribution requirements. However, the light bar is generally mounted on the casing through screw or glue. Therefore, once the light bar is mounted on the casing, the light bar is not readily to be removed or replaced. As a result, additional processes and cost may be required for maintenance and repair of the LED lamp.

What is needed, therefore, is an LED lamp which can overcome the disadvantages as described above.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric, assembled view of an LED lamp in accordance with an exemplary embodiment of the present disclosure.

FIG. 2 is a view similar to FIG. 1, but viewed from an opposite direction thereof

FIG. 3 is an enlarged, exploded view of a part of the LED lamp of FIG. 1.

FIG. 4 is a further exploded view of the LED lamp of FIG. 3.

FIG. 5 is a view similar to FIG. 4, but viewed from an opposite direction thereof.

### DETAILED DESCRIPTION

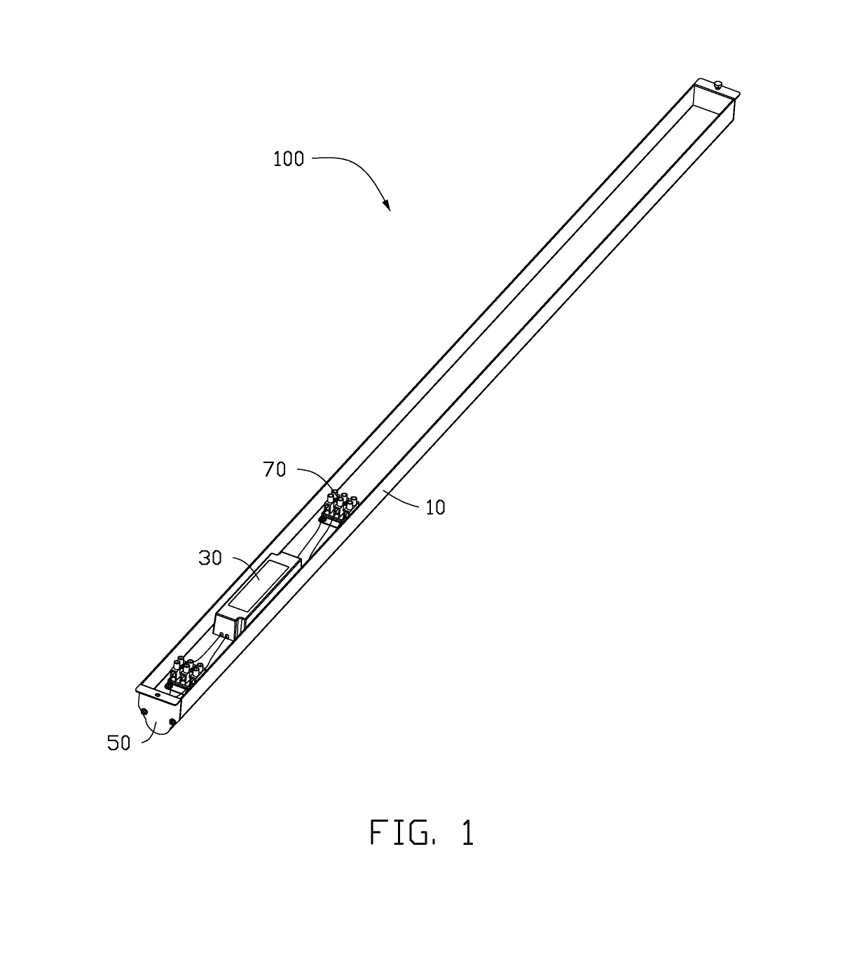

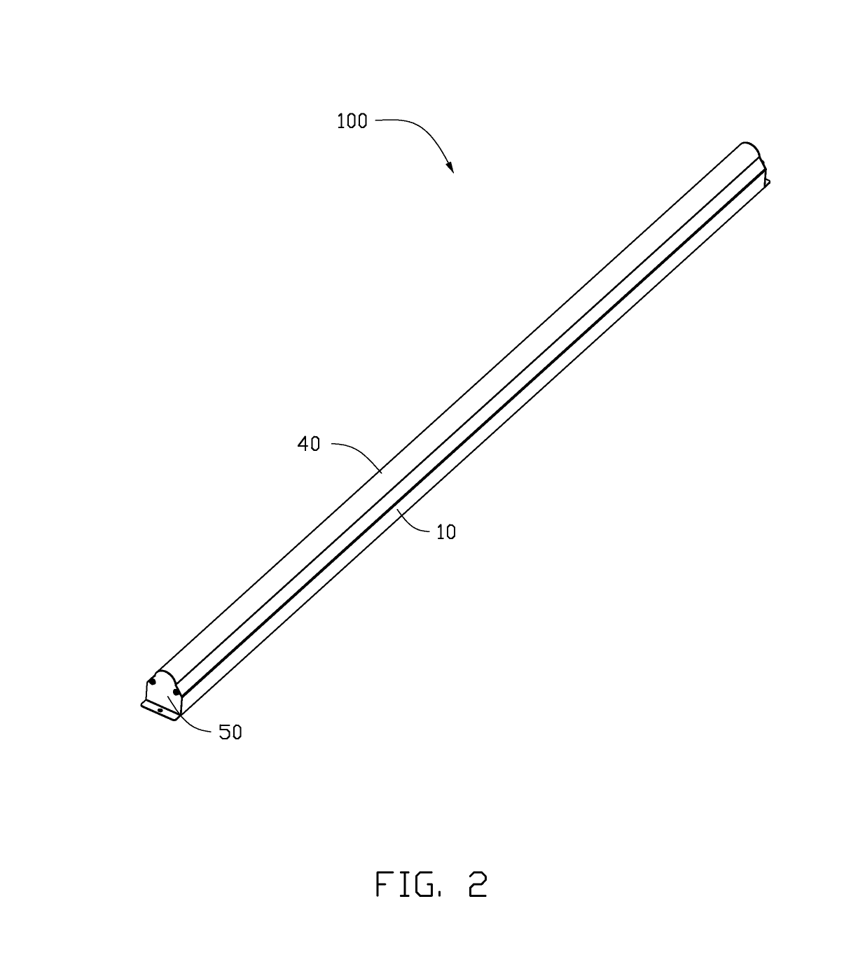

Referring to FIGS. 1 to 3, a light-emitting diode (LED) lamp 100 in accordance with an exemplary embodiment of the present disclosure is shown. The LED lamp 100 includes a frame 10, a light bar 20, a driving module 30, a lamp cover 40 and two side plates 50.

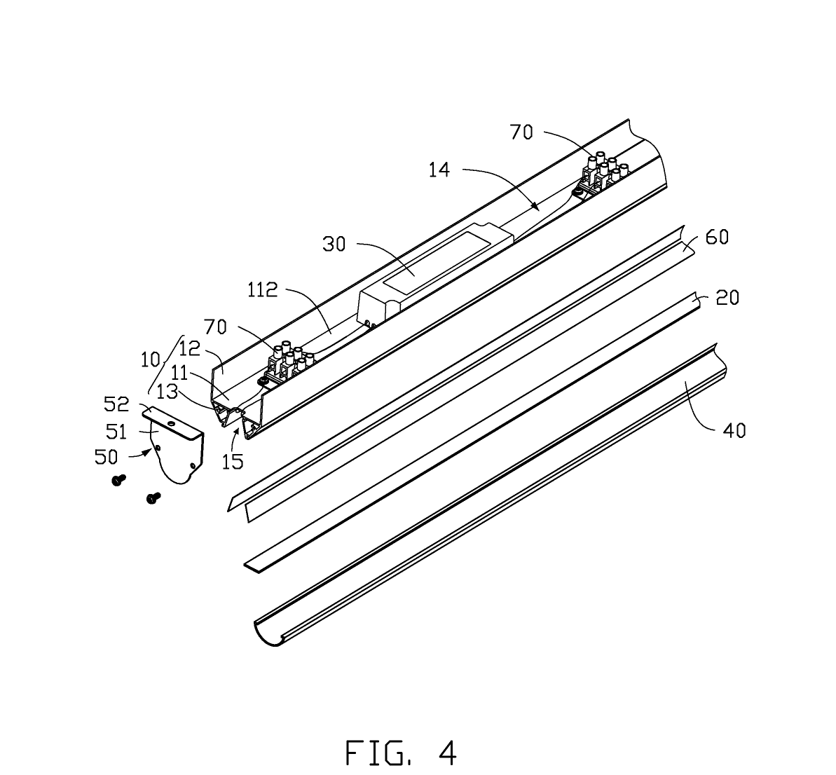

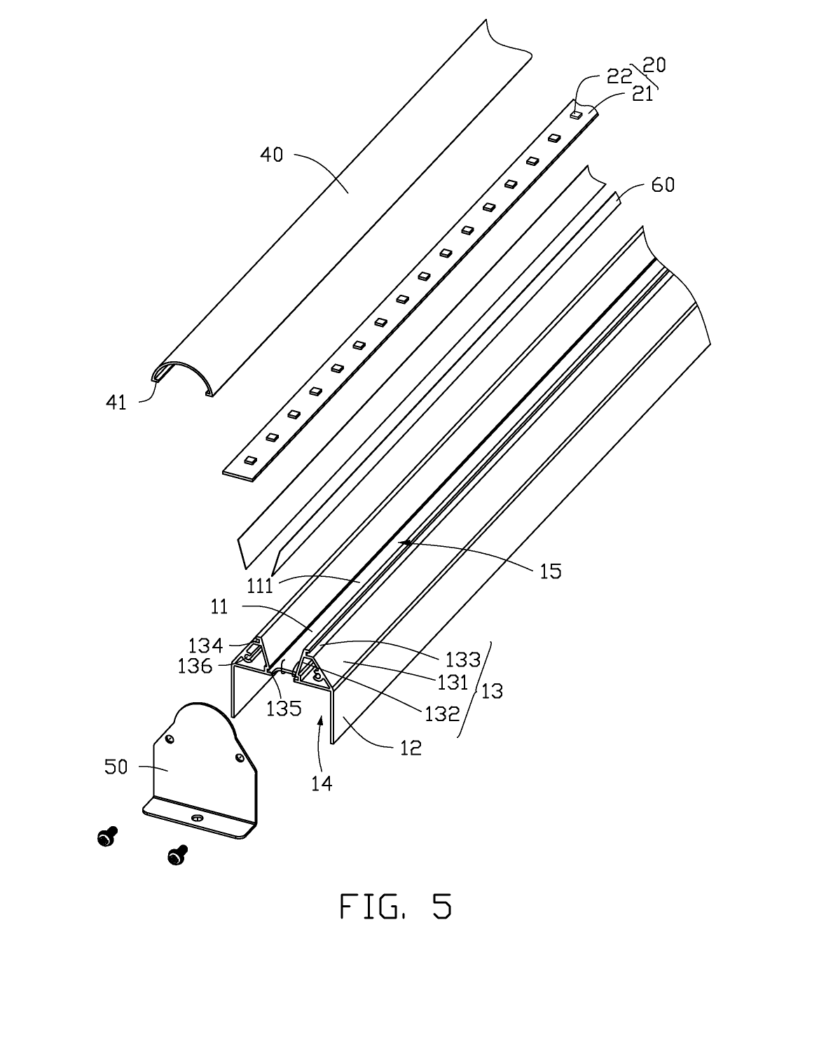

Referring to FIGS. 4 and 5, the frame 10 is elongated and has a cross section with an upper U-shaped sub-frame and two trapezium-shaped mounting portions 13 extending downwardly from two lateral sides of the U-shaped sub-frame. The frame 10 is made of a material exhibiting excellent thermal conductivity and light reflectivity, such as aluminum wherein the frame 10 can be formed by aluminum extrusion. The upper sub-frame of the frame 10 includes a supporting plate 11 and two sidewalls 12 extending upwardly from two opposite edges of the supporting plate 11. The supporting plate 11 is elongated and substantially rectangular. The supporting plate 11 includes a first surface 111 and a second surface 112 opposite the first surface 111. The two sidewalls 12 each extend from a lateral side of the second surface 112 of the supporting plate 11. The two sidewalls 12 are parallel to each other and perpendicular to the supporting plate 11. The two sidewalls 12 extend along a length direction of the supporting plate 11. The two sidewalls 12 and the second surface 112 of the supporting plate 11 together define a receiving room 14.

The two mounting portions 13 each have a hollow structure, thereby reducing a weight of the frame 10 and increasing a heat-dissipating area of the frame 10. The two mounting portions 13 are spaced from each other and extend along the length direction of the supporting plate 11. Each mounting portion 13 includes an outer wall 131, an inner wall 132 and a middle wall 133 interconnecting bottom ends of the outer and inner walls 131, 132. The outer wall 131 extends obliquely (i.e., downwardly and inwardly) from an outer side of the first surface 111 of the supporting plate 11. The outer wall 131 extends along the length direction of the supporting plate 11. The inner wall 132 extends obliquely (i.e., outwardly and downwardly) from a middle portion of first surface 111 of the supporting plate 11. The middle wall 133 is parallel to the supporting plate 11 and interconnects the outer wall 131 and inner wall 132. The middle wall 133 faces downwardly. The mounting portion 13 has a trapeziform shape in cross section. The two spaced inner walls 132 and a portion of the first surface 111 of the supporting plate 11 between the inner walls 132 together form a reflecting cup 15. The inner walls 132 extend away from each other along a lighting direction of the light bar 20. The reflecting cup 15 extends along the length direction of the supporting plate 11 for reflecting light emitted from the light bar 20. To further increase a reflectivity of the reflecting cup 15, a reflecting material can be coated thereon. The receiving room 14 and the reflecting cup 15 are at two opposite sides (i.e., top and bottom sides) of the supporting plate 11. Alternatively, a reflecting film 60 is attached on each of the inner walls 132 to enhance the reflectivity.

Two L-shaped appendages extend downwardly from the middle walls 133, respectively to thereby define two clipping grooves 134 each of which is defined below the middle wall 133 of one of the mounting portions 13. Each clipping groove 134 extends from each middle wall 133 away from the supporting plate 11 and extends horizontally away from the other middle wall 133. As shown in FIG. 5, the clipping groove 134 extends downwardly from the middle wall 133 and extends horizontally and outward. The clipping groove 134 extends along the length direction of the supporting plate 11. The clipping grooves 134 are used for receiving edges of the lamp cover 40 to thereby assemble the lamp cover 40 to the frame 10. The edges of the lamp cover 40 clip into the clipping grooves 134.

A part of the inner wall 132 of the mounting portion 13 which is close to the supporting plate 11 is recessed towards the outer wall 131 of the corresponding mounting portion 13 to define a slot 135. The slots 135 extend along the length direction of the supporting plate 11. An opening of the slot 135 faces an opening of the other slot 135 for receiving the light bar 20.

A screw groove 136 is defined on an inner surface of the outer wall 131 of each of the mounting portions 13. The screw groove 136 is formed in the hollow mounting portion 13 and extends along the length direction of the supporting plate 11. The screw groove 136 is C-shaped in cross section. The screw groove 136 is used for fixing the side plate 50 to the frame 10.

The light bar 20 includes a substrate 21 and a plurality of LEDs 22 arranged on the substrate 21 in a matrix. The substrate 21 is elongated and substantially a rectangular plate. In this embodiment, the plurality of LEDs 22 are arranged in a row along a length direction of the substrate 21. A thickness of the substrate 21 of the light bar 20 is corresponding to a height of each of the slots 135 of the frame 10, whereby the substrate 21 can be fixed to the frame 10 by inserting lateral edges of the substrate 21 into the slots 135.

Referring to FIG. 4, the driving module 30 is fixed on the second surface 112 of the supporting plate 11 of the frame 10 and is received in the receiving room 14. Two wiring junctions 70 are mounted on the supporting plate 11 and each of the wiring junctions 70 is deposited on one side of the driving module 30. The driving module 30 is electrically connected to the light bar 20 via one of the wiring junctions 70 and is electrically connected to external power via the other wiring junction 70.

A length of the lamp cover 40 matches that of the supporting plate 11. The lamp cover 40 is substantially semicircular in cross section, or the lamp cover 40 is substantially C-shaped in cross section. A hook 141 is formed on each edge of the lamp cover 40. The hooks 141 extend from the edge of the lamp cover 40 inwardly and horizontally along a length direction of the lamp cover 40. Each hook 141 is clipped in the clipping groove 134 of the frame 10 to fix the lamp cover 40 on the frame 10 firmly. The lamp cover 40 also acts as a dustproof cover for the plurality of LEDs 22.

The side plate 50 is mounted on each of two lateral sides of the frame 10 and the lamp cover 40. The side plate 50 includes a barrier sheet 51 and a folding sheet 52. The folding sheet 52 extends outward and horizontally from a top of the barrier sheet 51. Two screw holes (not labeled) corresponding to the screw grooves 136 are defined in the barrier sheet 51. The side plate 50 is fixed on a lateral side of the frame 10 and the lamp cover 40 by screws. Another screw hole (not labeled) is defined in the folding sheet 52 for fixing the LED lamp 100 onto a wall or a ceiling.

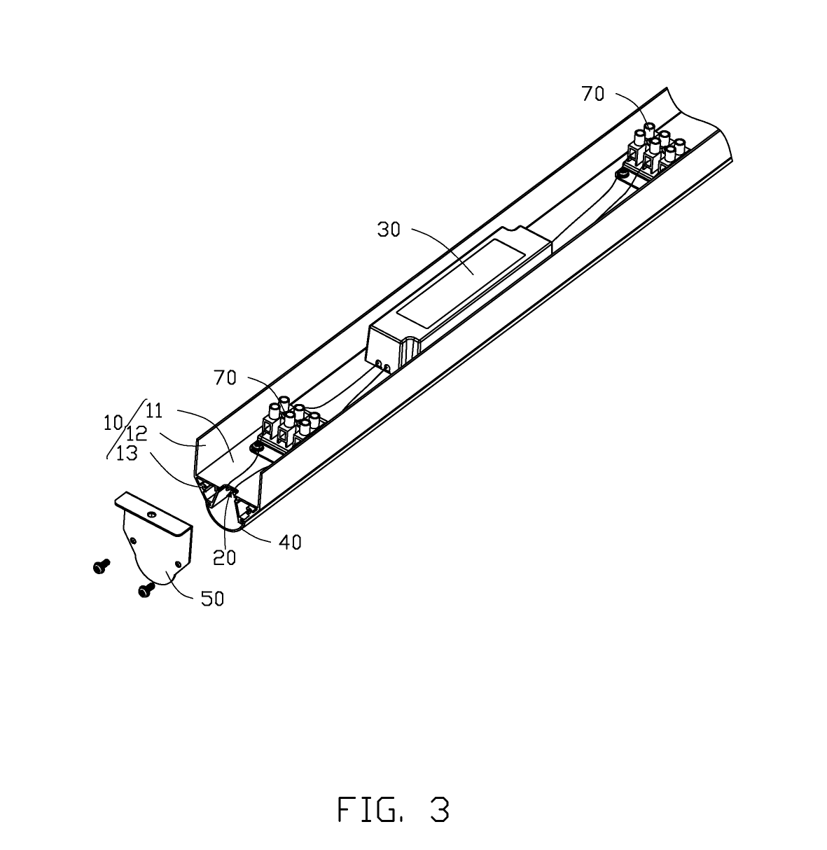

Referring to FIGS. 3 and 5 again, in assembly of the LED lamp 100, the light bar 20 is inserted into the slots 135 of the frame 10, by pushing the light bar 20 into the slots 135 from a lateral side of the supporting plate 11 until the light bar 20 is totally received in the slots 135 of the frame 10, thus mounting the light bar 20 to the frame 10. By this, the light bar 20 is fixed on the supporting plate 11 of the frame 10. The light bar 20 can be easily dismounted from the frame 10 by pulling the light bar 20 out of the slots 135. The driving module 30 and two wiring junctions 70 are fixed on the supporting plate 11 via screws. Wires are soldered on the light bar 20 to electrically connect the light bar 20 to the wiring junctions 70 and the driving module 30. The reflecting films 60 are attached on the inner walls 132 of the mounting portions 13. The lamp cover 40 is pushed towards the frame 10 from a lateral side of the frame 10 until the hooks 41 of the lamp cover 40 are totally received in the clipping grooves 134, thus mounting the lamp cover 40 to the frame 10. The lamp cover 40 can be easily dismounted from the frame 10 by pulling the lamp cover 40 away from the frame 10 until the hooks 41 are totally out of the clipping grooves 134. The side plates 50 are fixed on two lateral sides of the frame 10 via screws. Since the light bar 20 can be easily pulled out of the frame 10 to separate the light bar 20 from the frame 10, a replacement or a maintenance of the light bar 20 can be easily performed.

In the aforementioned embodiment, since the light bar 20 is mounted on the frame 10 in an easily dismountable way, the LED lamp 100 can change different light bars conveniently to generate different light distributions to meet different light distribution requirements without the necessity of redesigning the LED lamp 100. Therefore, the manufacturing cost of the LED lamp 100 can be lowered.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. A light-emitting diode lamp comprising:
a frame having two mounting portions each having an inner wall defining a slot therein, the inner wall projecting downwardly and outwardly;
a light bar fixed on the frame at one side thereof, the light bar being fixed to the frame by inserting the light bar into the slots of the frame and being separable from the frame by pulling the light bar out of the slots;
a driving module mounted on the frame at another side thereof, the driving module electrically connecting with the light bar; and
a lamp cover fixed on the frame and covering the light bar.

2. The light-emitting diode lamp of claim 1, wherein the frame comprises a supporting plate and two sidewalls, each sidewall extends upwardly from a lateral side of a top face of the supporting plate, and the two mounting portions are extended downwardly from a bottom face of the supporting plate.

3. The light-emitting diode lamp of claim 2, wherein the two sidewalls are parallel to each other and perpendicular to the supporting plate, and the two sidewalls and the supporting plate together define a receiving room for receiving the driving module therein.

4. The light-emitting diode lamp of claim 2, wherein the two mounting portions are hollow-structured and spaced from each other.

5. The light-emitting diode lamp of claim 4, wherein each mounting portion further comprises an outer wall and a middle wall, the outer wall extends downwardly and inwardly from the supporting plate, the inner wall extends downwardly and outwardly from the supporting plate, the middle wall interconnects the outer wall and the inner wall, the two opposite inner walls and a portion of the supporting plate between the two opposite inner walls together form a reflecting cup.

6. The light-emitting diode lamp of claim 5, wherein the slots are defined in the inner walls of the mounting portions at locations close to the supporting plate, and the slots recess towards the outer walls of the mounting portions, respectively.

7. The light-emitting diode lamp of claim 5, wherein a reflecting film is attached to the inner wall of each of the mounting portions.

8. The light-emitting diode lamp of claim 5, wherein two clipping grooves each are defined above the middle wall of each of the mounting portions to fix the lamp cover to the frame.

9. The light-emitting diode lamp of claim 8, wherein each clipping groove extends horizontally away from a corresponding inner wall.

10. The light-emitting diode lamp of claim 8, wherein a hook is formed on each edge of the lamp cover and the hook is clipped in a corresponding clipping groove of the frame to fix the lamp cover on the frame.

11. The light-emitting diode lamp of claim 1, wherein the light bar comprises a substrate and a plurality of LEDs mounted on the substrate.

12. The light-emitting diode lamp of claim 11, wherein the plurality of LEDs are arranged in a row along a length direction of the substrate.

13. The light-emitting diode lamp of claim 1 further comprising a side plate mounted on each lateral side of the frame and the lamp cover by screws.

14. The light-emitting diode lamp of claim 1 further comprising two wiring junctions mounted in the frame, and the driving module is electrically connected to the light bar via one wiring junction and is electrically connected to external power via the other wiring junction.

15. A light-emitting diode lamp comprising:
a frame defining a pair of slots therein;
a light bar fixed on the frame in a dismountable way, wherein the light bar is pushed into the slots of the frame to be mounted in the frame at one side thereof;
a driving module mounted in the frame at another side thereof, the driving module electrically connecting with the light bar; and
a lamp cover fixed on the frame and covering the light bar;
wherein the pair of slots are defined in two walls of the frame which extend away from each other along a light emitting direction of the light bar.

16. The light-emitting diode lamp of claim 15, wherein the frame comprises a supporting plate, two sidewalls, and two mounting portions, each sidewall extends from a lateral side of a top face of the supporting plate, and the mounting portions are extended downwardly from a bottom face of the supporting plate, the mounting portions having the two walls defining the pair of slots.

17. The light-emitting diode lamp of claim 16, wherein the pair of slots are defined in the two walls at locations close to the supporting plate, and openings of the pair of slots face each other and the pair of slots are recessed away from each other to receive the light bar therein.

18. The light-emitting diode lamp of claim 16, wherein two clipping grooves are defined in the frame, and two hooks are formed on two edges of the lamp cover, and each hook is clipped in a corresponding clipping groove to fix the lamp cover on the frame.

19. The light-emitting diode lamp of claim 15 further comprising a side plate mounted on each lateral side of the frame and the lamp cover by screws.
